(19) United States
(12) Patent Application Publication
(10) Pub. No.: US 2020/0097464 A1
(43) Pub. Date: Mar. 26, 2020

(54) CONTENT MANAGEMENT SYSTEM IMPLEMENTED USING A DATABASE STRUCTURE

(71) Applicant: salesforce.com, inc., San Francisco, CA (US)

(72) Inventors: Sridhar Subramaniam, Buffalo Grove, IL (US); Gayathri Ravichandran Geetha, San Francisco, CA (US); Kusum Kanwar, San Francisco, CA (US); VVK Chandra Gundamaraju, Fremont, CA (US); Andrea Conway, San Francisco, CA (US); Khushwant Singh, San Ramon, CA (US)

(21) Appl. No.: 16/397,855

(22) Filed: Apr. 29, 2019

Related U.S. Application Data
(60) Provisional application No. 62/734,586, filed on Sep. 21, 2018.

(51) Int. Cl. G06F 16/248; G06F 16/28; G06F 16/242; G06F 16/25

(52) U.S. Cl. CPC G06F 16/248; G06F 16/288; G06F 16/2423; G06F 16/252; G06F 16/2428

(57) ABSTRACT

Disclosed are some implementations of systems, apparatus, methods and computer program products providing cloud-based content management. In some examples, selected items of content may be obtained from different categories of data sources using one or more configurable curation processes. For instance, curation processes may include user-selectable curation, query-based curation using one or more user-configurable database queries and intelligence-driven curation. The selected content items may be aggregated to define a content collection, which may be provided according to various user-selectable layouts including one or more user-configurable layouts. The user-selectable layouts are capable of being rendered on a user device to graphically display, in an online forum, the selected content items according to a designated structure in which content of the selected content items is exposed as user-selectable graphical blocks for manipulation using one or more input devices.

### COPYRIGHT NOTICE

A portion of the disclosure of this patent document contains material, which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

This patent document generally relates to a content management system implemented using a database structure. More specifically, this patent document discloses techniques based on a loose coupling or de-coupling of content curation with content presentation.

### BACKGROUND

“Cloud computing” services provide shared network-based resources, applications, and information to computers and other devices upon request. In cloud computing environments, services may be provided by servers to users' computer systems via the Internet and wireless networks rather than installing software locally on users' computer systems. A user may interact with social networking systems, email systems, and instant messaging systems, by way of example, in a cloud computing environment.

### BRIEF DESCRIPTION OF THE DRAWINGS

The included drawings are for illustrative purposes and serve only to provide examples of possible structures and operations for the disclosed systems, apparatus, methods and computer program products for content management. These drawings in no way limit any changes in form and detail that may be made by one skilled in the art without departing from the spirit and scope of the disclosed implementations.

FIG. 1 shows an example of a content management system, in accordance with some implementations.

FIG. 2 shows an example of a user interface (UI) in which a community workspace for a social network community is integrated with content management system, in accordance with some implementations.

FIG. 3 shows an example of a UI in which a list of content items aggregated in a content collection is displayed, in accordance with some implementations.

FIGS. 4a-4c show examples of UIs in which different lists of content items aggregated in different content collections are displayed, in accordance with some implementations.

FIG. 5 shows an example of a UI for configuring a curation process to obtain selected content items from one or more data sources, in accordance with some implementations.

FIG. 6 shows an example of a UI including a control panel for selecting and configuring a layout of a content collection, in accordance with some implementations.

FIG. 7a shows an example of a UI including control panels for configuring a mapping of graphical blocks of a layout to a content collection, in accordance with some implementations.

FIG. 7b shows a flowchart for an example of a method of interacting with a UI, which may include control panels for configuring a mapping of graphical blocks of a layout to a content collection, in accordance with some implementations.

FIG. 8a shows a block diagram of an example of an environment in which an on-demand database service may be used in accordance with some implementations.

FIG. 8b shows a block diagram of an example of some implementations of elements of FIG. 8a and various possible interconnections between these elements.

FIG. 9a shows a system diagram of an example of architectural components of an on-demand database service environment, in accordance with some implementations.

FIG. 9b shows a system diagram further illustrating an example of architectural components of an on-demand database service environment, in accordance with some implementations.

FIG. 10 shows a flowchart for an example of a method of providing a content collection according to one or more user-selectable layouts, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as being implemented in a single operation may be alternatively implemented by way of multiple operations. In some implementations of the disclosed cloud-based content management systems, apparatus, methods, computer program products, etc., data such as content made available by a variety of different categories of data sources may be curated, aggregated and presented on a display device in a manner in which the presentation is loosely coupled or de-coupled from the curation and aggregation. In some implementations, this makes it possible for a content collection to be linked, also referred to herein as “hooked,” to the different data sources, while selected and aggregated items of content may be graphically displayed in a user interface (UI) in a variety of different user-selectable layouts.

For example, a user-selectable layout may be in the form of a carousel of knowledge articles. Additionally or alternatively, the same set of knowledge articles may be showcased as a grid on the same or another webpage. In some examples, the same grid may be configured to point to a customer relationship management (CRM) list view of a set of CRM content records or a related knowledge article collection that has been created. Layouts and exposed content items in the layout may be configured and selected using picklists and other settings in a control panel window.

In some implementations, to customize a layout or a graphical block of exposed content in a layout such as a tile, different parts of the tile may be mapped to a user-specified subset of fields of a category of database records, such as an account, case or other type of CRM content record stored in a CRM database. Both standard CRM objects and custom CRM objects may be used. For instance, a database system provider may make available standard CRM record templates and custom CRM record templates, where the custom CRM templates may be customized by a customer of the database system provider. Various other categories of database records may be curated and have similar configurable mappings, as further described below.

In some implementations, tenant developers using the disclosed techniques in a multi-tenant database environment may create, publish and archive content in a much faster and user-friendly platform.

In some implementations, disclosed techniques for data curation, aggregation and presentation may be performed in the context of an online forum such as an online social network group or social network community.

In some implementations, a content collection module may function as an intermediate curation layer, which abstracts two sides of a content management system. On one side, different kinds of data sources provide different kinds of content, as further explained herein. At the content collection module, this content may be curated manually (e.g., adding one content item at a time), by database queries (e.g., a CRM query), by artificial intelligence (AI), and/or using any other curation processes. Database queries may be configurable, for instance, by a developer working for a tenant in a multi-tenant database environment to whitelist particular standard and/or custom CRM content record types, such as accounts (standard), cases (standard), opportunities (standard), products (custom), orders (custom) and others. Likewise, links or hooks from a content collection module to specific data sources may also be customized using particular application programming interfaces (APIs) and other interfaces, as well as customized protocols, formats, etc.

For instance, a content collection module may be configured to curate content using one or more of the disclosed curation processes to select cases created in a CRM database within the last year or some other specified timeframe. The content collection may thus correspond to a case history listing all of the cases satisfying such criteria, and these records may correspond to a subset of the CRM content records accessible at the various data sources.

In some implementations, a mapping may control how to populate tiles or other graphical blocks of content in a layout, such as a carousel or grid. The mapping may identify particularly relevant fields of a CRM content record, or other type of database record, and may specify that only the field data stored in the identified fields are to be displayed as components of the tile when displayed in the layout. The components of the tile may be mapped to the identified record fields. At least in particular implementations, based, at least in part, on the loose coupling described herein, configurability and related features may be enhanced.

A rendered presentation of a layout, e.g., a grid of tiles, may be manipulated and otherwise acted upon by a developer or other end user, for instance, by dragging and dropping tiles or the entire grid of tiles onto a webpage under development. In some implementations, after an end user opens a collection in the form of a layout, both the content items and the data structure of the content items may be exposed. For instance, selected content items, such as a list of products, a list of custom objects, and/or a list of CRM objects, may be displayed using metadata to indicate the structure of the items in the list, such as the names and content of particular fields, such as, description, image, etc. In some examples, a user may click on a graphical icon representing a content collection, which may bring about rendering the collection in a layout in which items may be identified according to their content and structure. At least in particular implementations, the user does not need to know the details of what data sources were used, what curation processes were performed, etc., to be able to open a content collection by clicking on the content collection and using the collection for some desired purpose.

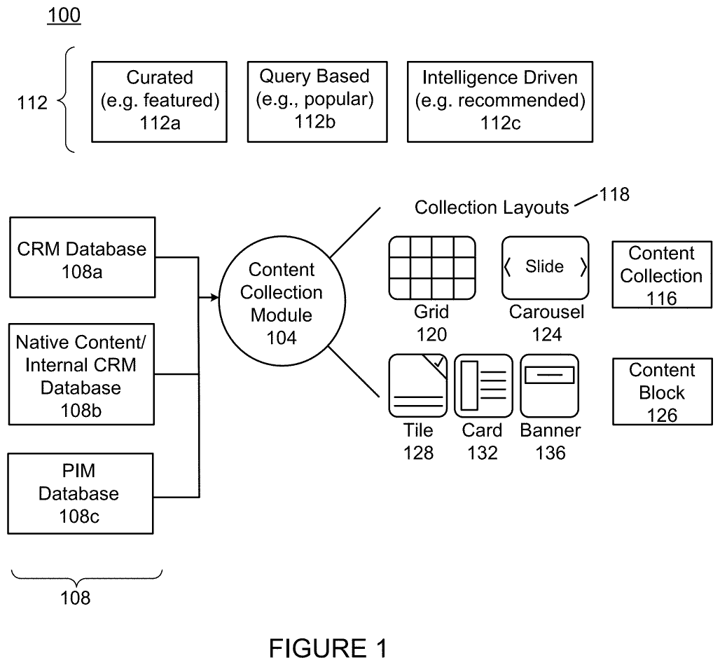

FIG. 1 shows an example of a content management system 100, in accordance with some implementations. In FIG. 1, system 100 includes a content collection module 104 in communication with a variety of different categories of data sources 108 such as a CRM database 108a storing CRM content records, an internal content management system (CMS) database 108b storing native content files and a product information management (PIM) database 108c storing PIM content records. In this example, CMS database 108b may be internal with respect to an enterprise such as a corporation serviced by system 100. Other various categories of data sources 108 not shown in FIG. 1 include external CMS databases that are external with respect to an organization, as well as enterprise resource planning (ERP) databases storing ERP content records. These various types of data sources may communicate with content collection module 104 using appropriate APIs and/or other suitable interfaces.

In FIG. 1, content collection module 104 may be configured to obtain selected content items from the various data sources 108 using one or more user-configurable curation processes 112. In some implementations, these curation processes 112 include user-selectable curation 112a, query-based curation 112b in which database queries may be configured by a user utilizing various criteria and executed on selected databases, and intelligence driven curation 112c using techniques such as AI. Examples of intelligence-driven curation may relate to an ability to create a news collection, such as a collection titled “Today's Trading News,” based on click-throughs, or other analytics, of individual news items on a particular news site. Other examples may include the ability for a user to personalize and/or rank content in a collection component based on user history (e.g., a highly-valued partner could see a “Leads Featured for You” based on his or her value rating (e.g., platinum, gold, silver, bronze) as well as product types and/or product categories in which the highly-valued partner specializes. The content module 104 in FIG. 1 may be configured to aggregate selected content items obtained using one or more of curation processes 112 to define a content collection 116. The content collection 116 may then be delivered to a user device serviced by system 100 and displayed according to any one of a variety of user-selectable layouts 118 such as a list, a grid 120, and a carousel 124. In some implementations, the user-selectable layouts 118 include user-configurable layouts as further described below. In a layout, such as grid 120 or carousel 124, the selected content items of content collection 116 may be graphically displayed according to a structure associated with the content items. For example, metadata embedded in or otherwise associated with one or more content items may indicate the structure according to which content items are graphically displayed. In some implementations, content of the displayed content items may be displayed in an online forum such as a social network group or community as user-selectable graphical blocks 126 for manipulation by a user using one or more input devices. For example, graphical blocks may be in the form of one or more tiles 128, one or more cards 132 and/or one or more banners 136. In some implementations, graphical blocks 126 may be user-configurable. For example, a user may be able to customize which data of a content item is displayed as well as being able to customize the formatting of the graphical display.

In FIG. 1, in some implementations, a layout may be user-configurable to map one or more portions of a graphical block, or a set of graphical blocks, to one or more user-designated fields of a particular record or set of records. For example, in particular implementations, a subset of fields of a CRM content record may be tagged as relevant to display in a graphical block.

In some other implementations, selected content items may be dynamically obtained by content collection module 104 in response to user input by way of a user device, where the user input operates to request the collection. Thus, as updates may be made to various data sources 108, up-to-date information may be retrieved and aggregated as a content collection 116 by content collection module 104 responsive to a user requests for such information.

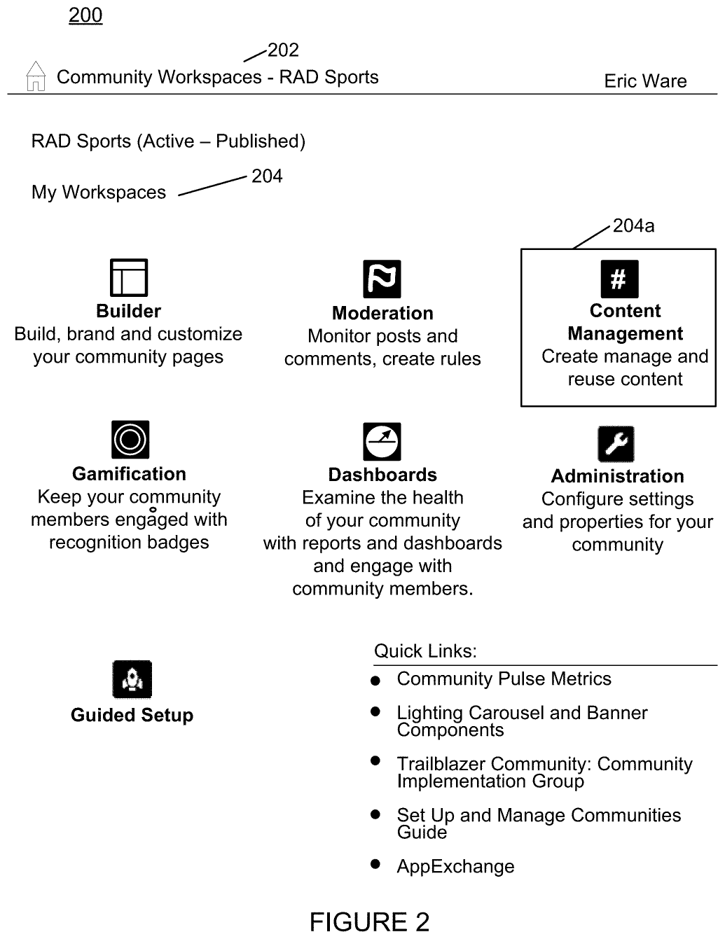

FIG. 2 shows an example of a user interface (UI) 200 in which a community workspace 202 for a social network community may be integrated with content management system 100, in accordance with some implementations. In FIG. 2, community workspace 202 includes a collection 204 of individual workspaces, labeled “My Workspaces.” Collection 204 may include a content management workspace 204a, which may be selected in UI 200 to initiate the creation, management, and use of content as disclosed herein including the operations of content collection module 104 of FIG. 1 and the rendering of one or more user-selectable layouts for the content collection.

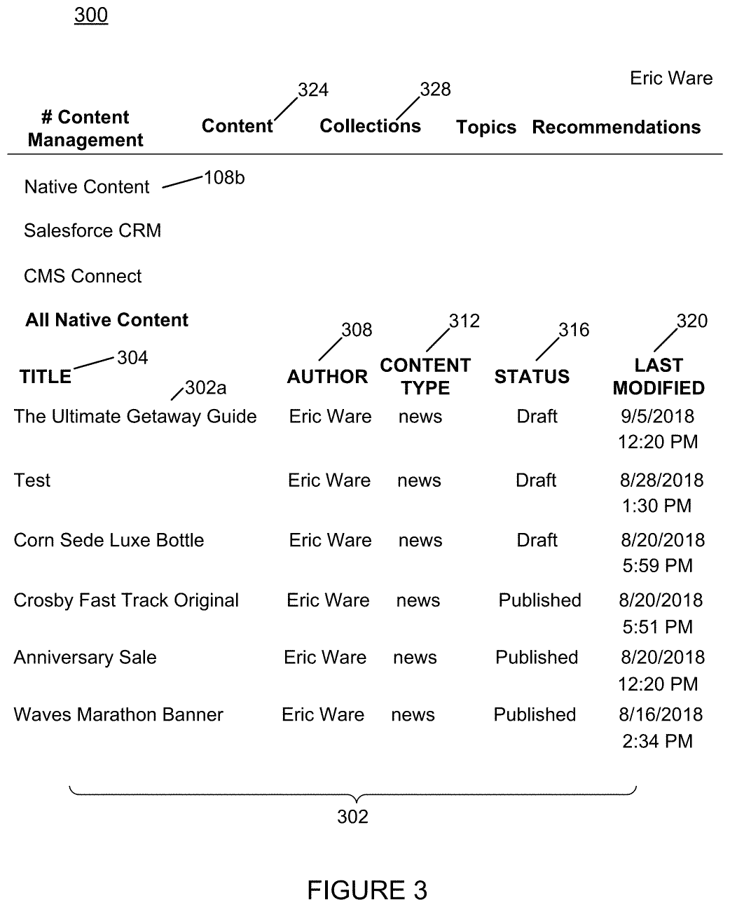

FIG. 3 shows an example of a UI 300, in which a list 302 of content items aggregated in a content collection is displayed, in accordance with some implementations. In FIG. 3, responsive to selection of content management workspace 204 a of FIG. 2, such as via a click or other action, in some implementations, list 302 may be obtained using one or more of the curation processes 112 described above with respect to FIG. 1. In this example, one or more of curation processes 112a-112c may have been previously performed to obtain native content items from internal CMS database 108b of FIG. 1. As shown in FIG. 3, each content item in list 302 may be identified by user-selected fields of a mapping to provide relevant information to the user to quickly identify and sort the content items. In this example, selected fields of a native content file include title 304, author 308, content type 312, status 316 and last modified timestamp 320. As mentioned above, the selection of particular fields in list 302 may be user-configured using a mapping, which may specify particular fields of native content files to be graphically displayed in a user-selectable layout such as a list, grid, carousel, etc. In UI 300, a content tab 324 may allow a user to select list 302, while a collections tab 328 may allow a user to see a list of content collections aggregated by content collection module 104 of FIG. 1 using a different curation process and/or different combination of curation processes.

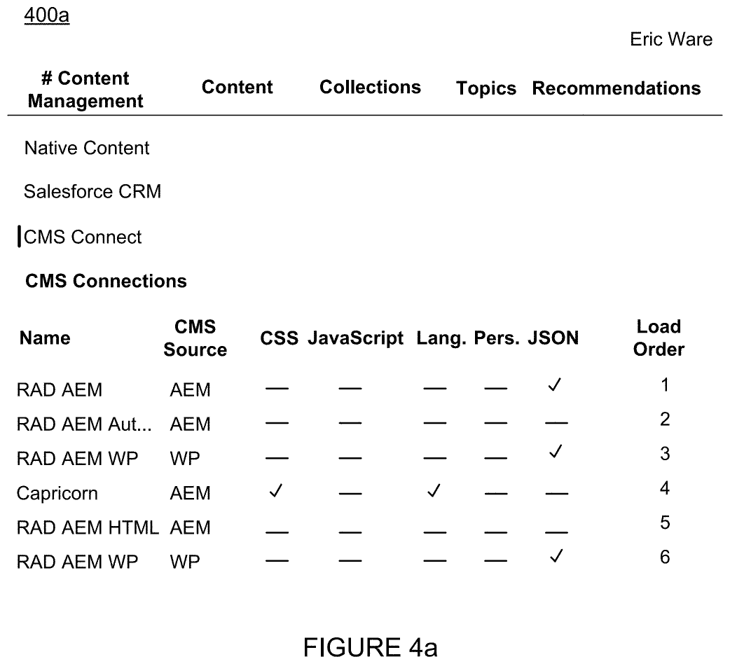

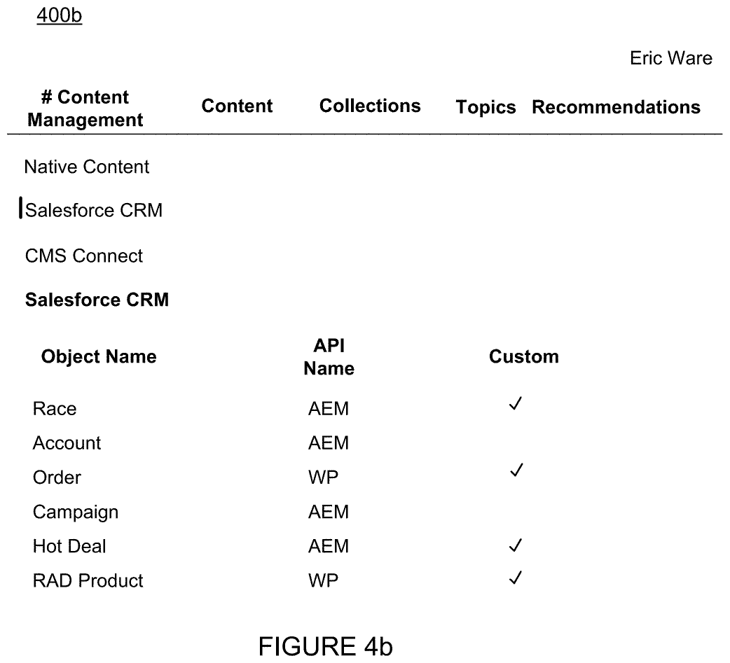

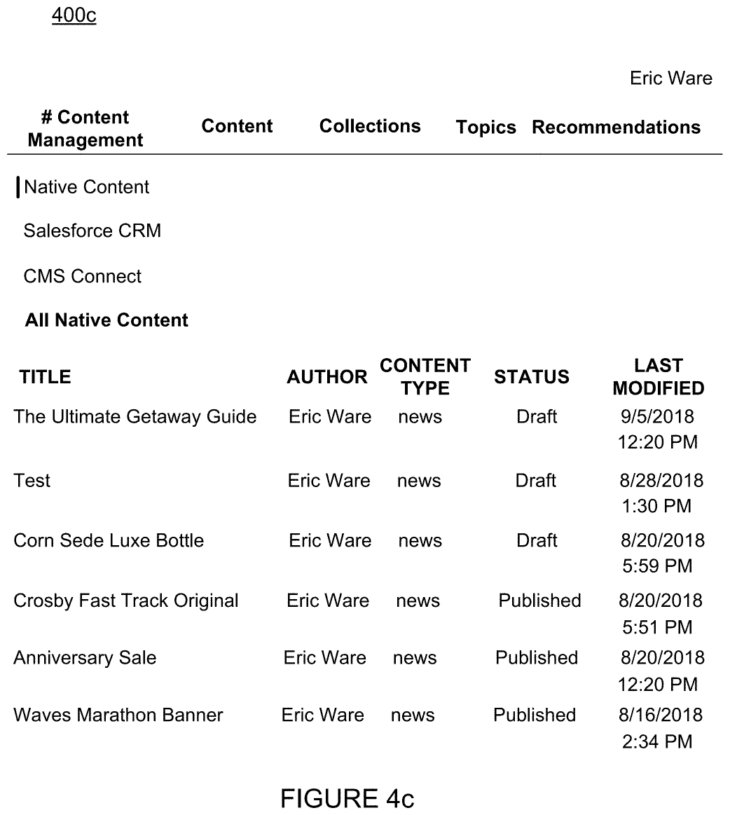

FIGS. 4a-4c shows examples of Uls 400a, 400b and 400c, in which different lists of content items aggregated in different content collections are displayed, in accordance with some implementations. In FIG. 4a, UI 400a shows a set of CMS content items, which indicate the names of particular CMS content files and the data sources where such files are stored, such as an internal or external CMS database. Various content items in the list of UI 400a may utilize various formats, such as

JavaScript Object Notation (JSON) and JavaScript. In UI 400b of FIG. 4b, a list of CRM records stored in CRM database 108a of FIG. 1 is shown. These CRM records may include standard objects as well as custom objects. List 302 of FIG. 3 is shown in UI 400c of FIG. 4c. The native content items in list 302 may be authored locally on a suitable development platform. In some implementations, as shown in FIGS. 4a-4c, user interfaces 400a, 400b, and 400c may permit customers to easily curate content from multiple sources in a relatively seamless manner. Content may be obtained, for example, from external CMS providers, from a CRM database, or by offering content locally on the community cloud.

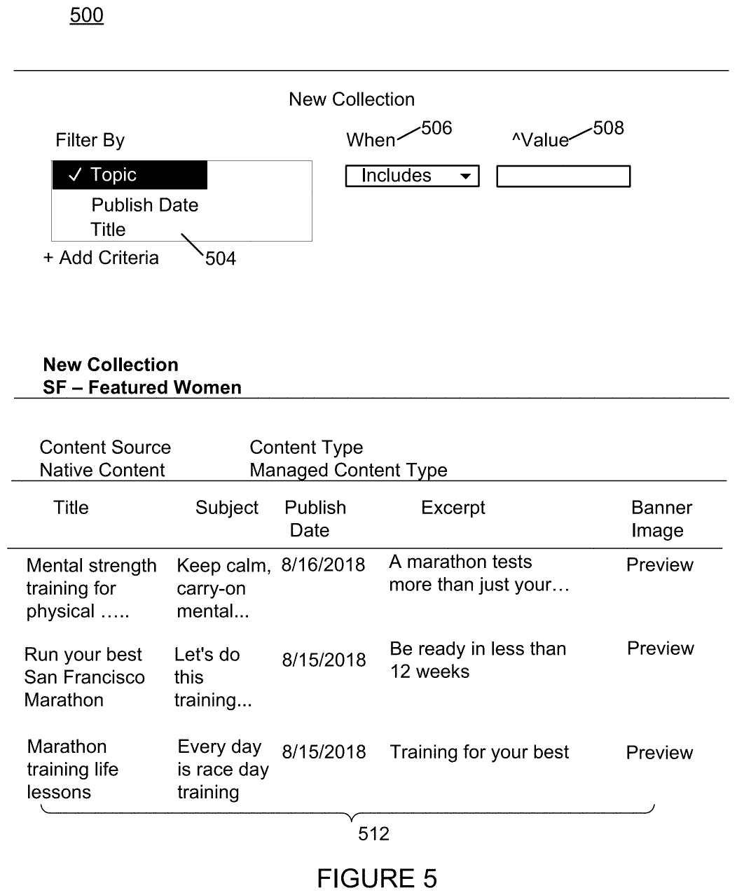

FIG. 5 shows an example of a UI 500 for configuring a curation process to obtain selected content items from one or more data sources, in accordance with some implementations. In FIG. 5, a drop-down menu 504 shows particular fields of content records to search with a database query. For instance, fields such as “topic,” “publish date” and “title” may be selected and may include criteria specified for a query to be run on files and/or records in one or more data sources. Additional fields such as a timeframe in “when” field 506 may be specified for the query. Numerical criteria may be entered using “value” field 508. Content items satisfying the query or queries may be aggregated in a content collection and rendered in a suitable layout such as a list 512. In some implementations, as shown in FIG. 5, UI 500 may permit creation of collections from different content sources, such as one or more CRM sources, one or more providers of native CMS, and/or other providers, and claimed subject matter is not limited in this respect.

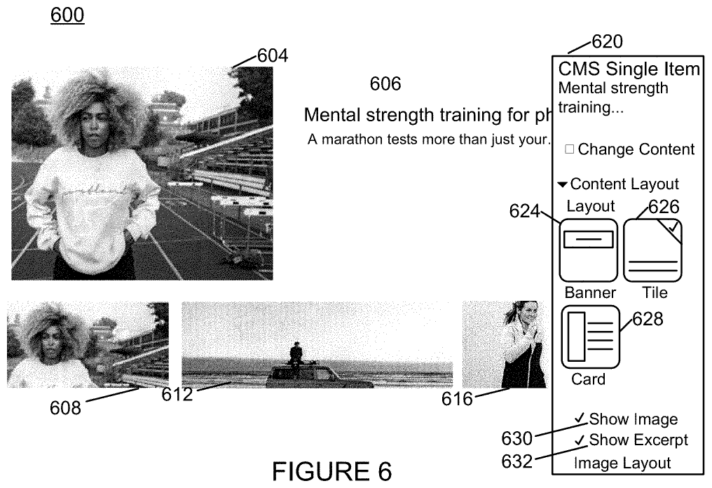

FIG. 6 shows an example of a UI 600 including a control panel 620 for selecting and configuring a layout of a content collection, in accordance with some implementations. In this example, a presentation of graphical blocks 606, 608, 612 and 616 may be customized utilizing control panel 620, which may be rendered as a sidebar of UI 600. In control panel 620, a user may select a banner 624, a tile 626 or a card 628 as the graphical block, which may cause the blocks to be presented in this form. In this particular illustration, banner 624 and card 628 have been selected. Thus, block 606 may be presented as a banner, while blocks 606, 608 and 612 may be presented as cards. Additional checkboxes 630 and 632 of control panel 620 may allow a user to determine whether to display the image of interest or an excerpt of the image. Accordingly, a full image 604 is shown in block 606, while excerpts of images are shown in blocks 608, 612 and 616. In some implementations, as shown in FIG. 6, by utilizing UI 600, content and presentation may be substantially decoupled from one another. Accordingly, at least in certain implementations, customers may represent the same data, from virtually any source, for example, in a variety of different layouts. Layouts may include standard layouts (e.g., out-of-the-box) or custom layouts.

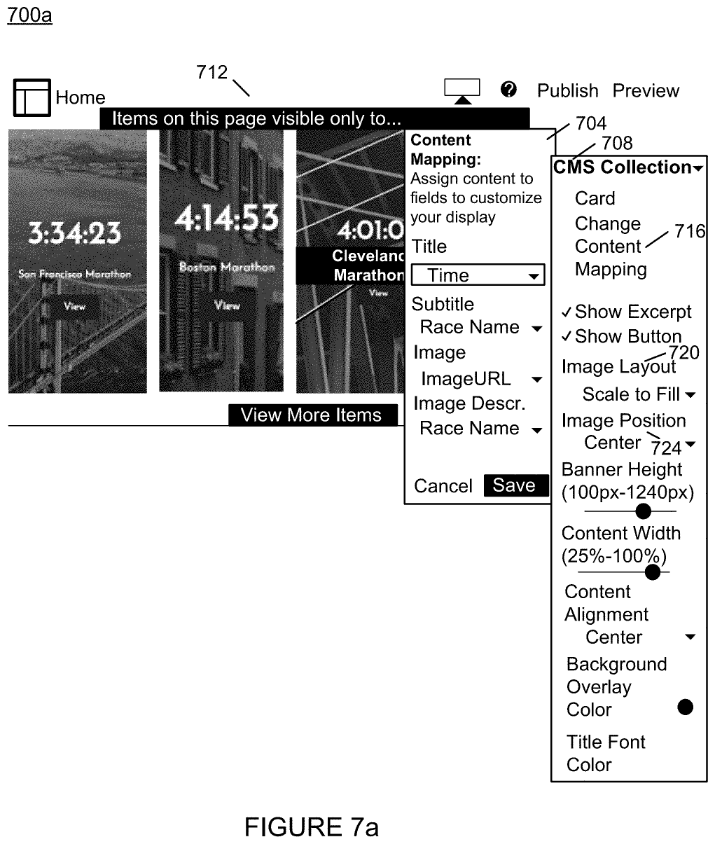

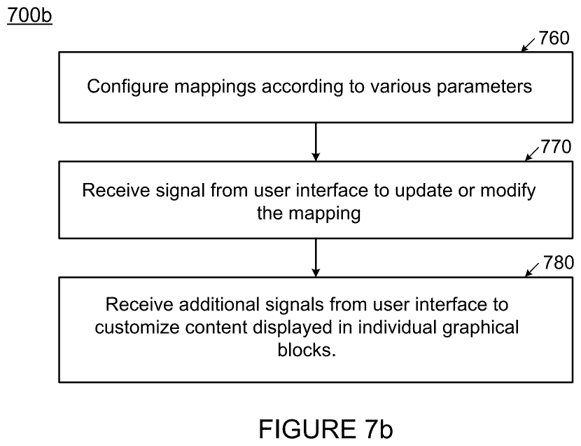

FIG. 7a shows an example of a UI 700a including control panels for configuring a mapping of graphical blocks of a layout to a content collection, in accordance with some implementations. In FIG. 7a, users may use control panels 704 and 708 to configure mappings according to various parameters. For example, in control panel 704, graphical blocks displayed in a layout 712 may be configured so as to include components exposing content of user-specified fields of a database record or file stored in any of the various data sources 108 of FIG. 1, for example. In the example of FIG. 7a, particular components of content such as title, subtitle, image and image description of the graphical blocks in layout 712 may be mapped, respectively, to a time field of a record storing a runner's recorded time for a marathon, a race name field storing a name of the marathon (such as San Francisco Marathon, Boston Marathon, etc.), a URL of a webpage with an image of interest, and the race name field. In FIG. 7a, in control panel 708, an existing mapping may be updated or modified using “change content mapping” button 716. Additional parameters for customizing what is displayed in individual graphical blocks may be specified using, in this example, an image layout picklist 720 with a parameter such as “scale to fill” and an image position picklist 724 with a parameter such as “center.” Other parameters such as banner height, content width, content alignment, background overlay color and tile font color may be specified. In this way, using control panels 704 and 708, a customer may map content from various data sources without having to manually program selections to quickly create a professional and attractive presentation of a layout of graphical blocks, which may be customized as desired for additional use and processing. It may be appreciated that the UI of FIG. 7a may permit customers to easily map content originating from a data provider, without accompanying code, to permit creation of a professional-looking user interface. In certain implementations, mapping of graphical blocks of a layout to a content collection, such as shown in FIG. 7a, may be constructed by an independent software vendor and/or a developer utilizing application program interfaces to construct CMS components and layouts. Following preparation of a layout, the developer can choose content for insertion into the layout as well as mapping of content accordance with the layout. In some implementations, a page builder/experience fragment builder utilized in a content management system may assist in configuring layouts and/or content fragments. Application program interfaces may be exposed to permit creation of content types, such as product announcements utilizing a title (longtext), URL, product images (image fields), and so forth.

FIG. 7b shows a flowchart for an example of a method 700b of interacting with a UI 700, which may include control panels for configuring a mapping of graphical blocks of a layout to a content collection, in accordance with some implementations. At 760 of FIG. 7b, mappings are configured to various parameters. In some implementations, a user may utilize control panels, such as control panel 704 and 708 of FIG. 7a. For example, control panel 704 displays graphical blocks, by way of a layout 712, which is configured to include components exposing content of the user-specified fields of a database record or a file stored in any of the various data sources 108 of FIG. 1.

The method of FIG. 7b continues at 770, in which a signal is received from a user interface to update or modify the mapping. In some implementations, 770 includes receiving a signal responsive to a user selecting a “change content mapping” button, such as button 716 of FIG. 7a. The method of FIG. 7b continues at 780, in which additional signals are received from a user interface to customize content displayed in individual graphical blocks. In some implementations, 780 includes receiving a signal responsive to a user selecting, for example, to scale an image by selection of a “scale to fill” button displayed in an image position picklist, such as picklist 724. An image position picklist permits a user to center, for example, an image within an individual graphical block.

Some, but not all, of the techniques described or referenced herein may be implemented utilizing or in conjunction with a social networking system. Social networking systems have become a popular way to facilitate communication among people, any of whom may be recognized as users of a social networking system. One example of a social networking system is Chatter®, provided by salesforce.com, inc. of San Francisco, Calif. salesforce.com, inc. is a provider of social networking services, CRM services and other database management services, any of which may be accessed and used in conjunction with the techniques disclosed herein in some implementations. In some, but not all, implementations, these various services may be provided in a cloud computing environment, for example, in the context of a multi-tenant database system. Thus, the disclosed techniques may be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and may be implemented in the context of various other database systems and/or social networking systems such as Facebook®, LinkedIn®, Twitter®, Google+®, Yammer® and Jive® by way of example only.

Some social networking systems may be implemented in various settings, including organizations. For instance, a social networking system may be implemented to connect users within an enterprise such as a company or business partnership, or a group of users within such an organization. For instance, Chatter® may be used by employee users in a division of a business organization to share data, communicate, and collaborate with each other for various social purposes often involving the business of the organization. In the example of a multi-tenant database system, each organization or group within the organization may be a respective tenant of the system, as described in greater detail below.

In some social networking systems, users may access one or more social network feeds, which include information updates presented as items or entries in the feed. Such a feed item may include a single information update or a collection of individual information updates. A feed item may include various types of data including character-based data, audio data, image data and/or video data. A social network feed may be displayed in a graphical user interface (GUI) on a display device such as the display of a computing device as described below. The information updates may include various social network data from various sources and may be stored in a database system. In some, but not all, implementations, the disclosed methods, apparatus, systems, and computer program products may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail below, allows a user to track the progress of that record when the user is subscribed to the record. Updates to the record, also referred to herein as changes to the record, are one type of information update that may occur and be noted on a social network feed such as a record feed or a news feed of a user subscribed to the record. Examples of record updates include field changes in the record, updates to the status of a record, as well as the creation of the record itself. Some records are publicly accessible, such that any user may follow the record, while other records are private, for which appropriate security clearance/permissions are a prerequisite to a user following the record.

Information updates may include various types of updates, which may or may not be linked with a particular record. For example, information updates may be social media messages submitted by a user or may be otherwise generated in response to user actions or in response to events. Examples of social media messages include: posts, comments, indications of a user's personal preferences such as “likes” and “dislikes,” updates to a user's status, uploaded files, and user-submitted hyperlinks to social network data or other network data such as various documents and/or web pages on the Internet. Posts may include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data may be included in, linked with, or attached to a post or comment. For example, a post may include textual statements in combination with a JPEG image or animated image. A like or dislike may be submitted in response to a particular post or comment. Examples of uploaded files include presentations, documents, multimedia files, and the like.

Users may follow a record by subscribing to the record, as mentioned above. Users may also follow other entities such as other types of data objects, other users, and groups of users. Feed tracked updates regarding such entities are one type of information update that may be received and included in the user's news feed. Any number of users may follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. Some implementations of such a personal social network page include a user's profile page, for example, in the form of a web page representing the user's profile. In one example, when the first user is following the second user, the first user's news feed may receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a feed. Members of the group may view and post to this group feed in accordance with a permissions configuration for the feed and the group. Information updates in a group context may also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data may include general information, such as name, title, phone number, a photo, a biographical summary, and a status, e.g., text describing what the user is currently doing. As mentioned below, the data may include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record may have a data structure defined by the database service (a standard object) or defined by a user (custom object). For example, a record may be for a business partner or potential business partner (e.g., a client, vendor, distributor, etc.) of the user, and may include information describing an entire company, subsidiaries, or contacts at the company. As another example, a record may be a project that the user is working on, such as an opportunity (e.g., a possible sale) with an existing partner, or a project that the user is trying to get. In some implementations of a multi-tenant database system, each record for the tenants has a unique identifier stored in a common table. A record has data fields that are defined by the structure of the object (e.g., fields of certain data types and purposes). A record may also have custom fields defined by a user. A field may be another record or include links thereto, thereby providing a parent-child relationship between the records.

The terms “social network feed” and “feed” are used interchangeably herein and generally refer to a combination (e.g., a list) of feed items or entries with various types of information and data. Such feed items may be stored and maintained in one or more database tables, e.g., as rows in the table(s), that may be accessed to retrieve relevant information to be presented as part of a displayed feed. The term “feed item” (or feed element) generally refers to an item of information, which may be presented in the feed such as a post submitted by a user. Feed items of information about a user may be presented in a user's profile feed of the database, while feed items of information about a record may be presented in a record feed in the database, by way of example. A profile feed and a record feed are examples of different types of social network feeds. A second user following a first user and a record may receive the feed items associated with the first user and the record for display in the second user's news feed, which is another type of social network feed. In some implementations, the feed items from any number of followed users and records may be combined into a single social network feed of a particular user.

As examples, a feed item may be a social media message, such as a user-generated post of text data, and a feed tracked update to a record or profile, such as a change to a field of the record. Feed tracked updates are described in greater detail below. A feed may be a combination of social media messages and feed tracked updates. Social media messages include text created by a user, and may include other data as well. Examples of social media messages include posts, user status updates, and comments. Social media messages may be created for a user's profile or for a record. Posts may be created by various users, potentially any user, although some restrictions may be applied. As an example, posts may be made to a wall section of a user's profile page (which may include a number of recent posts) or a section of a record that includes multiple posts. The posts may be organized in chronological order when displayed in a GUI, for instance, on the user's profile page, as part of the user's profile feed. In contrast to a post, a user status update changes a status of a user and may be made by that user or an administrator. A record may also have a status, the update of which may be provided by an owner of the record or other users having suitable write access permissions to the record. The owner may be a single user, multiple users, or a group.

In some implementations, a comment may be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update may include text generated by the database system in response to the event, to be provided as one or more feed items for possible inclusion in one or more feeds. In some implementations, the data may initially be stored, and then the database system may later use the data to create text for describing the event. Both the data and/or the text may be a feed tracked update, as used herein. In various implementations, an event may be an update of a record and/or may be triggered by a specific action by a user. Which actions trigger an event may be configurable. Which events have feed tracked updates created and which feed updates are sent to which users may also be configurable. Social media messages and other types of feed updates may be stored as a field or child object of the record. For example, the feed may be stored as a child object of the record.

A “group” is generally a collection of users. In some implementations, the group may be defined as users with a same or similar attribute, or by membership. In some implementations, a “group feed,” also referred to herein as a “group news feed,” includes one or more feed items about any user in the group. In some implementations, the group feed also includes information updates and other feed items that are about the group as a whole, the group's purpose, the group's description, and group records and other objects stored in association with the group. Threads of information updates including group record updates and social media messages, such as posts, comments, likes, etc., may define group conversations and change over time.

An “entity feed” or “record feed” generally refers to a feed of feed items about a particular record in the database. Such feed items may include feed tracked updates about changes to the record and posts made by users about the record. An entity feed may be composed of any type of feed item. Such a feed may be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed may be displayed on a page associated with the particular user. In another example, feed items in a profile feed could include posts made by the particular user and feed tracked updates initiated based on actions of the particular user.

Some non-limiting examples of systems, apparatus, and methods are described below for implementing database systems and enterprise level social networking systems in conjunction with the disclosed techniques. Such implementations may provide more efficient use of a database system. For instance, a user of a database system may not easily know when important information in the database has changed, e.g., about a project or client. Such implementations may provide feed tracked updates about such changes and other events, thereby keeping users informed.

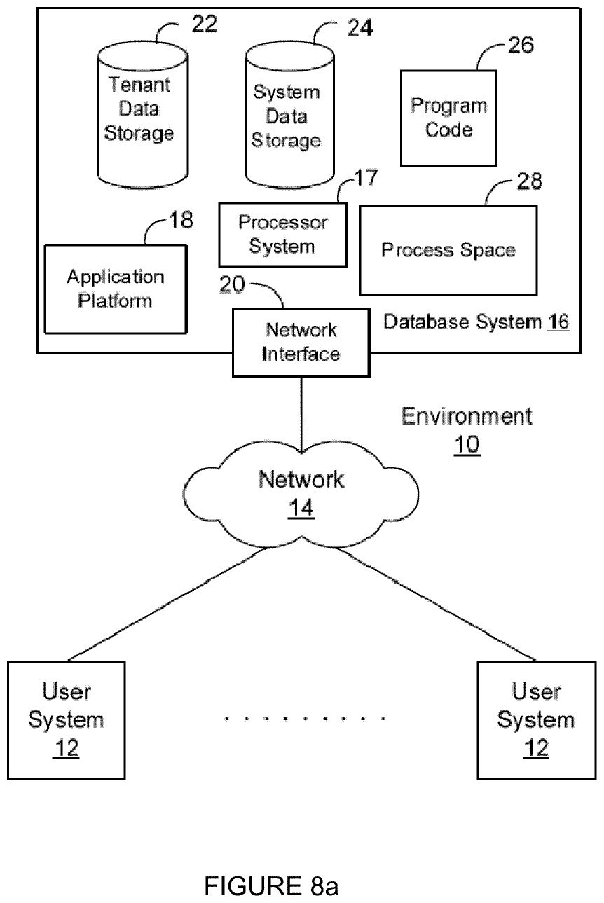

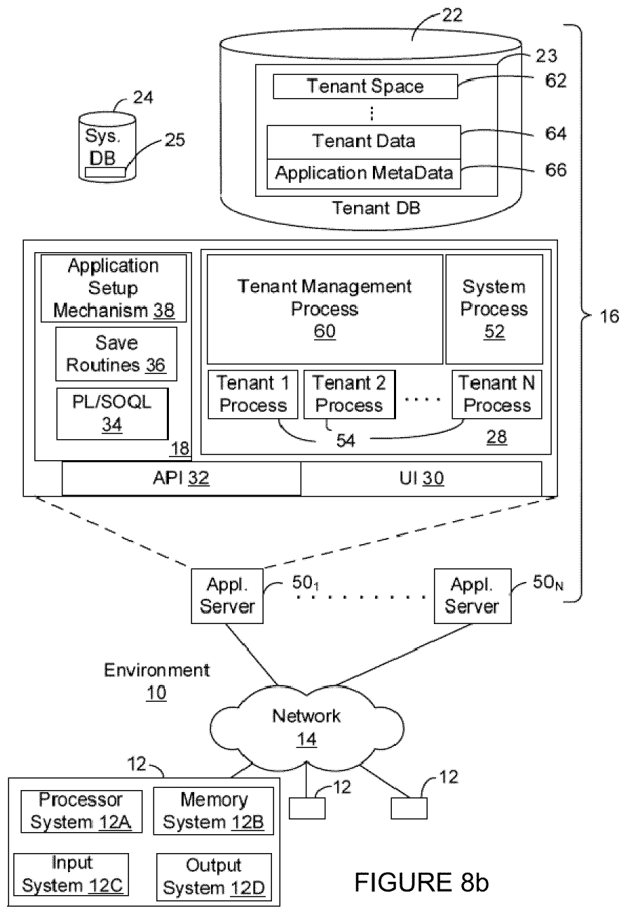

FIG. 8a shows a block diagram of an example of an environment 10 in which an on-demand database service exists and may be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 may be a handheld and/or portable computing device such as a mobile phone, a smartphone, a laptop computer, or a tablet. Other examples of a user system include computing devices such as a work station and/or a network of computing devices. As illustrated in FIG. 8a (and in more detail in FIG. 8b) user systems 12 might interact via a network 14 with an on-demand database service, which is implemented in the example of FIG. 8a as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at a first permission level may have access to applications, data, and database information accessible by a second permission level user (e.g., a lower permission level), but may not have access to certain applications, database information, and data accessible by a user at a different (e.g., higher) permission level. Thus, different users may have different capabilities with regard to accessing and modifying application and database information, depending on a user's security or permission level, also called authorization.

Network 14 is any network or combination of networks of devices that communicate with one another. For example, network 14 may be any one or any combination of a LAN (local area network), WAN (wide area network), telephone network, wireless network, point-to-point network, star network, token ring network, hub network, or other appropriate configuration. Network 14 may include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In some implementations, system 16, shown in FIG. 8a, implements a web-based CRM system. For example, in some implementations, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 8a and 8b, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 8a include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer.” User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein may refer to a display of a computer system such as a monitor or touch-screen display, and may refer to any computing device having display capabilities such as a desktop computer, laptop, tablet, smartphone, a television set-top box, or wearable device such Google Glass® or other human body-mounted display apparatus. For example, the display device may be used to access data and applications hosted by system 16, and to perform searches on stored data, and otherwise allow a user to interact with various GUI pages that may be presented to a user. As discussed above, implementations are suitable for use with the Internet, although other networks may be used instead of or in addition to the Internet, such as an intranet, an extranet, a virtual private network (VPN), a non-TCP/IP based network, any LAN or WAN or the like.

According to some implementations, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media may have instructions stored thereon/in, that may be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations may be realized in any programming language that may be executed on a client system and/or server or server system such as, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein may be implemented as single databases, a distributed database, a collection of distributed databases, a database with redundant online or offline backups or other redundancies, etc., and might include a distributed database or storage network and associated processing intelligence.

FIG. 8b shows a block diagram of an example of some implementations of elements of FIG. 8a and various possible interconnections between these elements. That is, FIG. 8b also illustrates environment 10. However, in FIG. 8b elements of system 16 and various interconnections in some implementations are further illustrated. FIG. 8b shows that user system 12 may include processor system 12A, memory system 12B, input system 12C, and output system 12D. FIG. 8b shows network 14 and system 16. FIG. 8b also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 8a. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 8b, system 16 may include a network interface 20 (of FIG. 8a) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which may be either a physical arrangement and/or a logical arrangement of data. Within each tenant storage space 62, user storage 64 and application metadata 66 might be similarly allocated for each user. For example, a copy of a user's recently used items, which may include a user's most recently used (MRU) items, may be stored within user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In some implementations, therefore, an interface system implementing a load balancing function (e.g., an F5 Big-IP load balancer) is communicably coupled between the application servers 50 and the user systems 12 to distribute requests to the application servers 50. In some implementations, the load balancer uses a least connections algorithm to route user requests to the application servers 50. Other examples of load balancing algorithms, such as round robin and observed response time, also may be used. For example, in certain implementations, three consecutive requests from the same user could access three different application servers 50, and three requests from different users could access the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., may be maintained and accessed by a user system having nothing more than network access, the user may manage his or her sales efforts and cycles from any of many different user systems. For example, if a salesperson is visiting a customer and the customer has Internet access in their lobby, the salesperson may obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database may generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

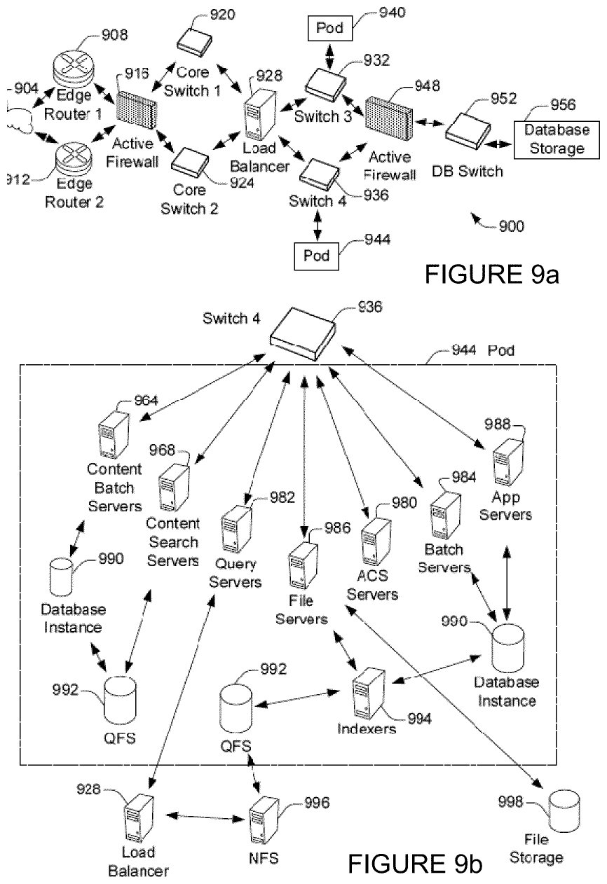

FIG. 9a shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine may be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 9a and 9b, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 9a and 9b, some implementations of an on-demand database service environment may include anywhere from one to many devices of each type. Also, the on-demand database service environment need not include each device shown in FIGS. 9a and 9b, or may include additional devices not shown in FIGS. 9a and 9b.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 9b.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 9a and 9b.

FIG. 9b shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query servers 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata may be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

In some implementations, one or more application servers or other servers described above with reference to FIGS. 8a and 8b include a hardware and/or software framework configurable to execute procedures using programs, routines, scripts, etc. Thus, in some implementations, one or more of application servers 50₁-50_{N} of FIG. 8b may be configured to initiate performance of one or more of the operations described above with reference to FIGS. 1-7b by instructing another computing device to perform an operation. In some implementations, one or more application servers 50₁-50_{N} carry out, either partially or entirely, one or more of the disclosed operations described with reference to FIGS. 1-7b. In some implementations, app servers 988 of FIG. 9b support the construction of applications provided by the on-demand database service environment 900 via the pod 944. Thus, an app server 988 may include a hardware and/or software framework configurable to execute procedures to partially or entirely carry out or instruct another computing device to carry out one or more operations disclosed herein, including operations described above with reference to FIGS. 1-7b. In alternative implementations, two or more app servers 988 may cooperate to perform or cause performance of such operations. Any of the databases and other storage facilities described above with reference to FIGS. 8a, 8b, 9a and 9b may be configured to store lists, articles, documents, records, files, and other objects for implementing the operations described above with reference to FIGS. 1-7b. For instance, lists of available communication channels associated with share actions for sharing a type of data item may be maintained in tenant data storage 22 and/or system data storage 24 of FIGS. 8a and 8b. By the same token, lists of default or designated channels for particular share actions may be maintained in storage 22 and/or storage 24. In some other implementations, rather than storing one or more lists, articles, documents, records, and/or files, the databases and other storage facilities described above may store pointers to the lists, articles, documents, records, and/or files, which may instead be stored in other repositories external to the systems and environments described above with reference to FIGS. 8a, 8b, 9a and 9b.

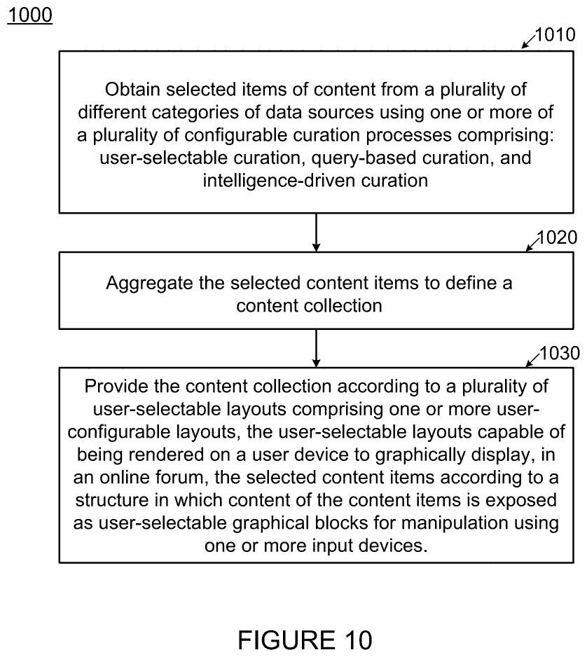

FIG. 10 shows a flowchart for an example of a method 1000 of providing a content collection according to one or more user-selectable layouts, in accordance with some implementations. The method of FIG. 10 begins at 1010, which includes obtaining selected items of content from a plurality of different categories of data sources using one or more of a plurality of configurable curation processes. In some implementations, such curation processes include user-selectable curation, such as described in relation to curation 112a of FIG. 1. In some implementations, a curation process includes a query-based curation process, such as described in relation to curation 112b of FIG. 1. In some implementations, a curation process includes an intelligence-driven curation process, such as described in relation to curation 112c of FIG. 1.

The method of FIG. 10 continues at 1020, which includes aggregation of the selected content items to define a content collection. 1020 can be performed, by a content collection module, such as content collection module 104 described in relation to FIG. 1. The method of FIG. 10 continues at 1030, which includes providing the content collection according to a plurality of user-selectable layouts including one or more user-configurable layouts. In some implementations, the user-selectable layouts are capable of being rendered on a user device to graphically display, such as in an online forum, the selected content items. At 1030, the selected content items are displayed according to a structure in which content of the content items is exposed as user-selectable graphical blocks for manipulation using one or more input devices.

In one or more implementations, a user-configurable layout described with reference to FIG. 10 is configurable to map at least a portion of components of the user-selectable graphical blocks to user-designated fields of one or more types of CRM content records stored in a database. In one or more implementations, the different categories of data sources are be user-selectable and include a CRM database storing a plurality of CRM content records. In one or more implementations, a data source includes a CMS database internal with respect to an organization on behalf of which the CMS database is provided (e.g., in which the CMS database stores a plurality of native content files). In one or more implementations, a data source includes a CMS database external with respect to the organization (wherein the external CMS database stores a plurality of external content files). In one or more implementations, a data source includes a product information management (PIM) database storing a plurality of PIM content records. In one or more implementations, a data source includes an enterprise resource planning (ERP) database storing a plurality of ERP content records.

In one or more implementations, user-selectable layouts can include one or more of: a list, a grid or a carousel. In addition, the user-selectable graphical blocks can include one or more tiles, one or more cards, or one or more banners. In one or more implementations, the user-selectable graphical blocks include user-configurable graphical blocks. In one or more implementations, the structure according to which the selected content items are graphically displayed are based, at least in part, on metadata associated with the one or more of the selected content items.

While some of the disclosed implementations have been described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations may be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (ROM) devices and random access memory (RAM) devices. A computer-readable medium may be any combination of such storage devices.

Any of the operations and techniques described in this application may be implemented as software code to be executed by a processor using any suitable computer language such as, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A cloud-based content management system comprising:
a database system utilizing a server system comprising one or more hardware processors, the database system configurable to cause:
obtaining selected items of content from a plurality of different categories of data sources using one or more of a plurality of configurable curation processes comprising:
user-selectable curation,
query-based curation using one or more user-configurable database queries, and
intelligence-driven curation;
aggregating the selected content items to define a content collection; and
providing the content collection according to a plurality of user-selectable layouts comprising one or more user-configurable layouts,
the user-selectable layouts capable of being rendered on a user device to graphically display, in an online forum, the selected content items according to a structure in which content of the selected content items is exposed as user-selectable graphical blocks for manipulation via one or more input devices.

2. The system of claim 1, wherein the user-selectable layouts are configurable to map at least a portion of components of the user-selectable graphical blocks to user-designated fields of one or more types of customer relationship management (CRM) content records stored in a database.

3. The system of claim 1, wherein the different categories of data sources are user-selectable and comprise one or more of:
a customer relationship management (CRM) database storing a plurality of CRM content records,
a content management system (CMS) database internal with respect to an organization on behalf of which the database system is provided, the internal CMS database storing a plurality of native content files,
a CMS database external with respect to the organization, the external CMS database storing a plurality of external content files,
a product information management (PIM) database storing a plurality of PIM content records, or
an enterprise resource planning (ERP) database storing a plurality of ERP content records.

4. The system of claim 1, wherein:
the user-selectable layouts comprise one or more of: a list, a grid or a carousel, and
the user-selectable graphical blocks comprise one or more tiles, one or more cards, or one or more banners.

5. The system of claim 1, wherein the user-selectable graphical blocks comprise user-configurable graphical blocks.

6. The system of claim 1, wherein the structure according to which the selected content items are graphically displayed is based, at least in part, on metadata associated with one or more of the selected content items.

7. The system of claim 1, wherein the selected content items are dynamically obtained responsive to a user input requesting the content collection.

8. A computer program product comprising computer-readable program code capable of being executed by one or more processors when retrieved from a non-transitory computer-readable medium, the computer-readable program code comprising instructions configurable to cause:
obtaining selected items of content from a plurality of different categories of data sources using one or more of a plurality of configurable curation processes comprising:
user-selectable curation,
query-based curation using one or more user-configurable database queries, and
intelligence-driven curation;
aggregating the selected content items to define a content collection; and
providing the content collection according to a plurality of user-selectable layouts comprising one or more user-configurable layouts,
the user-selectable layouts capable of being rendered on a user device to graphically display, in an online forum, the selected content items according to a structure in which content of the selected content items is exposed as user-selectable graphical blocks for manipulation via one or more input devices.

9. The computer program product of claim 8, wherein the computer-readable program code comprises additional instructions configurable to cause the user-selectable layouts to be configurable to map at least a portion of components of the user-selectable graphical blocks to user-designated fields of one or more types of customer relationship management (CRM) content records stored in a database.

10. The computer program product of claim 8, wherein the computer-readable program code comprises additional instructions configurable to cause the different categories of data sources to be user-selectable and to comprise one or more of:
a customer relationship management (CRM) database storing a plurality of CRM content records,
a content management system (CMS) database internal with respect to an organization on behalf of which the CMS database is provided, the CMS database storing a plurality of native content files,
a CMS database external with respect to the organization, the external CMS database storing a plurality of external content files,
a product information management (PIM) database storing a plurality of PIM content records, or
an enterprise resource planning (ERP) database storing a plurality of ERP content records.

11. The computer program product of claim 8, wherein the computer-readable program code comprises additional instructions configurable to cause the user-selectable layouts to comprise one or more of: a list, a grid or a carousel, and
the user-selectable graphical blocks are to comprise one or more tiles, one or more cards, or one or more banners.

12. The computer program product of claim 8, wherein the computer-readable program code comprises additional instructions configurable to cause the user-selectable graphical blocks to be user-configurable.

13. The computer program product of claim 8, wherein the computer-readable program code comprises additional instructions configurable to cause the structure according to which the selected content items are to be graphically displayed is to be based, at least in part, on metadata associated with one or more of the selected content items.

14. The computer program product of claim 8, wherein the computer-readable program code comprises additional instructions configurable to cause content items to be dynamically obtained responsive to a user input to request the content collection.

15. A method comprising:
obtaining selected items of content from a plurality of different categories of data sources using one or more of a plurality of configurable curation processes comprising:
user-selectable curation,
query-based curation using one or more user-configurable database queries, and
intelligence-driven curation;
aggregating the selected content items to define a content collection; and
providing the content collection according to a plurality of user-selectable layouts comprising one or more user-configurable layouts,
the user-selectable layouts capable of being rendered on a user device to graphically display, in an online forum, the selected content items according to a structure in which content of the selected content items is exposed as user-selectable graphical blocks for manipulation using one or more input devices.

16. The method of claim 15, wherein a user-configurable layout, of the one or more user configurable layouts, is configurable to map at least a portion of components of the user-selectable graphical blocks to user-designated fields of one or more types of customer relationship management (CRM) content records stored in a database.

17. The method of claim 15, wherein the different categories of data sources are user-selectable and comprise one or more of:
a customer relationship management (CRM) database storing a plurality of CRM content records,
a content management system (CMS) database internal with respect to an organization on behalf of which the CMS database is provided, the CMS database storing a plurality of native content files,
a CMS database external with respect to the organization, the external CMS database storing a plurality of external content files,
a product information management (PIM) database storing a plurality of PIM content records, or
an enterprise resource planning (ERP) database storing a plurality of ERP content records.

18. The method of claim 15, wherein:
the user-selectable layouts comprise one or more of: a list, a grid or a carousel, and
the user-selectable graphical blocks comprise one or more tiles, one or more cards, or one or more banners.

19. The method of claim 15, wherein the user-selectable graphical blocks comprise user-configurable graphical blocks.

20. The method of claim 15, wherein the structure according to which the selected content items are graphically displayed is based, at least in part, on metadata associated with one or more of the selected content items.
